(19) United States
(12) Patent Application Publication
(10) Pub. No.: US 2025/0057188 A1
(43) Pub. Date: Feb. 20, 2025

(54) OPTIMISING IMMUNE RESPONSE IN PIGS THROUGH MICRO-NUTRIENTS

(71) Applicant: DSM IP ASSETS B.V., Heerlen (NL)

(72) Inventors: Elodie BACOU, Kaiseraugst (CH); Yanhong LUO, Kaiseraugst (CH); Ursula MCCORMACK, Kaiseraugst (CH); Luis Fernando ROMERO MILLAN, Kaiseraugst (CH); Viviane VERLHAC, Kaiseraugst (CH); Maria WALSH, Kaiseraugst (CH)

(21) Appl. No.: 18/713,952

(22) PCT Filed: Nov. 30, 2022
(86) PCT No.: PCT/EP2022/083851

§ 371 Date: May 28, 2024

Related U.S. Application Data
(60) Provisional application No. 63/284,185, filed on Nov. 30, 2021.

(51) Int. Cl. A23K 10/16; A23K 20/163; A23K 20/174; A23K 20/20; A23K 50/30

(52) U.S. Cl. CPC A23K 10/16; A23K 20/163; A23K 20/174; A23K 20/20; A23K 50/30

(57) ABSTRACT

Disclosed embodiments concern a composition comprising mannan-derived oligosaccharides orycast cell wall product and vitamin C. vitamin E, vitamin D3, and selenium. The disclosedembodiments further concern a method of administering the above composition as a feedadditive to supplement the feed of. farm animals. particularly for sows and piglets. The disclosedmethod is for promoting the immunity of pigs.

### TECHNICAL FIELD

The invention relates to animal farming. More specifically, the invention relates to a combination solution of mannan-derived oligosaccharides, vitamin C. vitamin E, vitamin D3 and organic selenium, and uses thereof for increasing the immunity of pigs, especially sows and piglets, at animal farm.

### BACKGROUND INFORMATION

Modulating the immune system through nutritional management can be an important tool to ameliorate the negative impact of disease and improve animal health and performance.

Mannan-derived oligosaccharides, vitamin C. vitamin E, vitamin D3 and organic selenium (Se) have been used in animal feed additive for various purposes but their impact on the immunity of farm animal, when used in combination, was not studies.

Mannan-derived oligosaccharides (MOS) are one type of prebiotics. They are known as feed additives which help to improve the health of production animals. MOS acts as a type of prebiotics and is found to exert beneficial immune-modulating effects. For example, MOS supplementation has been show to promote growth and/or immune function in aquatic animals (U.S. application Ser. No. 15/914,543). A clay product was found to treating early mortality syndrome (EMS)/acute hepatopancreatic necrosis disease (AHPND) in aquatic animals such as shrimps (U.S. application Ser. No. 14/815,811). Yeast cell wall products were found to improve the food conversion rate (FCR) in aquatic animals such as shrimps (U.S. application Ser. No. 16/765,648). Yeast cell walls were also found to be effective in treating enteric disease in aquatic animals (U.S. application Ser. No. 14/044,546).

There is a need in the art for a safe, economical and effective method of increase the immunity of farm animals. An effective manner to enhance the immunity of farm animals, especially piglets, would aid in the expansion of animal farming industry and the affordability of consumer on animal meat as part of their food.

### DETAILED DESCRIPTION OF THE INVENTION

Stress is known to influence the immune system of piglets, thus impacting growth. The objective of this study was to evaluate the effect of an immunity solution premix containing complementary antioxidants (Vit E and C, and organic Se), cell proliferation activator vitamin D3, especially 25-OH-D3, and phagocytic activity enhancer (yeast cell walls) on piglet growth and immune response following a vaccine challenge.

Modulating the immune system through nutritional management can be an important tool to ameliorate the negative impact of disease and improve animal health and performance. The piglet immune system development is highly dependent on the sow, so the sow gestation and lactation period is an important time to begin nutritional intervention. In addition, the immune system is highly complex, thus the appropriate stimulation and enhancement of different immune cells can be achieved only through a multi-component nutritional approach, including vitamin D3, E and C, selenium and yeast cell wall product.

### Compositions

Disclosed herein are embodiments of a composition for use in animal farming and formulated for feeding to farm animals. Such animal may be raised for human consumption.

Certain disclosed embodiment of the composition comprises mannan-derived oligosaccharides (MOS) and may further comprise probiotics. In some embodiments, the composition further comprises one or more types of vitamins and/or selenium. In some preferred embodiment, the composition further comprises vitamin D3, vitamin C and vitamin E. In some embodiments, the composition further comprises one or more of the ingredients selected from the following list: vitamin C, vitamin E, vitamin D3, and selenium. In one embodiment, the above MOS-containing composition is a nutritional feed additive. In a specific embodiment, the nutritional feed additive is an animal feed made by DSM Nutritional Products LLC under the commercial name Immunity Solutions.

Mannan-derived oligosaccharides may be made from any composition which comprises MOS. In one embodiment, MOS is derived from or in the form of yeast cell wall extract. In another embodiment, MOS is derived from or in the form of un-lysed yeast cell.

In some embodiments, the feed additive comprises yeast cell wall extract and an adhesive agent. In other embodiments, the feed additive comprises yeast cell wall extract, an adhesive agent and a feedstuff.

In some embodiment, the feed additive comprises between 1% and 15%, between 1% and 10%, or between 5% and 10% MOS or yeast cell wall extract. In some embodiment, the feed additive comprises at least 1% (w/w), at least 3% (w/w), at least 5% (w/w), at least 8% (w/w), at least 10% (w/w), at least 15% (w/w), or at least 18% (w/w) MOS or yeast cell wall extract.

In one embodiment, the composition is a feedstuff. In another embodiment, the composition is a feedstuff compositing a base nutritional composition and one or more feed additive. In one embodiment the feed additive comprise MOS, vitamin C, vitamin E, vitamin D3, and selenium. In one embodiment, the feedstuff is an animal feedstuff. In a specific embodiment, the feedstuff is a pig feed.

### Methods for Enhancing Immunity of Farm Animals

It has now been surprisingly found in the course of the present invention that by adding a mixture of mannan-derived oligosaccharides, vitamin C, vitamin E, vitamin D3, and selenium to the diet of farm animal, the immunity of animal can be significantly promoted. Specifically, it has been observed that piglets or sows fed with animal feed containing the above mixture has significant boost in immunity response comparing to animals which are not fed with the above mixture.

### EXAMPLES

Example 1

Optimising Immune Response in Vaccine-Challenged Piglets Through Micro-Nutrients Micro

A 42d study using 144 piglets (4/pen; 12 pens/treatment) weaned at ˜28 days were assigned to one of three treatments; 1) Control, no vaccine, 2) Control, vaccine, and 3) Control, solution, vaccine. Tetanus-Toxoid (TT) vaccine (1ml Tetapur®) was provided on d8 and d35. Body weight and feed intake were recorded to evaluate growth, and blood was collected from 10 pigs/treatment on d1, 8, 35, & 41 to evaluate the immune response. A multifactor ANOVA, followed by post-hoc multiple comparison tests, was used to evaluate the impact of treatment and time, with significance at P=0.05. Pen was the experimental unit for growth, with the piglet used for immune parameters.

The solution increased feed intake (749 vs. 711 g/day; P=0.038) resulting in a numerically better body weight (27.2 vs. 26.7 kg) and feed conversion (1.535 vs. 1.565) compared to the control. The vaccine challenge was successful as indicated by elevated levels of TT specific IgG in vaccinated piglets. Following the vaccine challenge, immunity solution reduced lysozyme activity, an antibacterial peptide, and lowered plasma antioxidant capability. The immunity solution decreased phagocytosis in granulocytes, associated with removal of pathogens from the body. There was a tendency for higher SOD activity, involved in protecting cells from oxidative damage, compared to treatment 2. These results indicate that the immunity solution helped pigs maintain, if not improve, their growth performance in stressful conditions, by regulating their immune response, thereby avoiding the diversion of energy away from growth to fuel the immune system.

Example 2

### A Multi-Component Approach to Optimize Nursery Piglet Immunity Starting with the Sow

This trial aimed at evaluating the effect of the supplementation of Immunity Solution to the sow and their progeny on piglet immune response and performance. Forty-eight sows (1st parity) and 144 progeny were used in this trial. There were 2 dietary treatments: control and Immunity Solution. The trial lasted for 9 days of gestation, 21 days of lactation and 7 days of post-weaning. A T-test was used to compare the control and Immunity Solution treatments. Results showed that Immunity Solution supplemented to the sows increased vitamin E level in sow plasma (P=0.01) at farrowing day and in colostrum (P=0.06), which in turn supported numerically higher vitamin E status in suckling piglets plasma (P=0.13). In addition, Immunity Solution provided to the sow significantly increased the number of leukocytes, lymphocytes and monocytes in piglets at weaning day (P<0.01). After weaning, Immunity Solution supplemented piglets had higher plasma IgG concentrations on d 7 post-weaning (P<0.05) compared to the control piglets. Therefore, optimised micronutrition provided to sows and their progeny can be an effective means of supporting piglets immune system development and creating more resistance to disease during the post-weaning period.

1. An animal feed composition comprising a base nutritional feed and Mannan- derived oligosaccharides (MOS), vitamin C, vitamin E, vitamin D3, and selenium.

2. The animal feed of claim 1, wherein said feed is fed to a farm animal to enhance its immunity.

3. A method of increasing the immunity of a farm animal, comprising administering a nutritional feed additive comprising a mixture of mannan-derived oligosaccharides (MOS), vitamin C, vitamin E, vitamin D3, and selenium to said animal, wherein the immunity of the animal fed with said nutritional feed additive is higher than the control group of animal which is fed with the same nutritional feed additive but without said mixture.

4. The method of claim 3, wherein said vitamin D3 is 25 (OH) D3.

5. The method of claim 3, wherein said MOS are derived from yeast.

6. The method of claim 3, wherein said MOS are derived from yeast cell walls.
